(19) United States
(12) Patent Application Publication
(10) Pub. No.: US 2006/0013956 A1
(43) Pub. Date: Jan. 19, 2006

(54) Method and apparatus for providing shear-induced alignment of nanostructure in thin films

(76) Inventors: Dan E. Angelescu, Danbury, CT (US); Judith H. Waller, Oxford (GB); Mingshaw W. Wu, San Jose, CA (US); Paul M. Chaikin, Pennington, NJ (US); Richard A. Register, Princeton Junction, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/011,495

(22) Filed: Dec. 14, 2004

Related U.S. Application Data
(60) Provisional application No. 60/563,652, filed on Apr. 20, 2004.

(51) Int. Cl. B05D 3/02; B05D 1/40

(52) U.S. Cl. 427/331; 427/372.2

(57) ABSTRACT

A method and apparatus is disclosed for providing shear-induced alignment of nanostructures, such as spherical nanodomains, self-assembled nanodomains, and particles, in thin films, such as block copolymer (BCP) thin films. A silicon substrate is provided, and a thin film is formed on the substrate. A pad is then applied to the thin film, and optionally, a weight can be positioned on the pad. Optionally, a thin fluid layer can be formed between the pad and the thin film to transmit shear stress to the thin film. The thin film is annealed and the pad slid in a lateral direction with respect to the substrate to impart a shear stress to the thin film during annealing. The shear stress aligns the nanostructures in the thin film. After annealing and application of the shear stress, the pad is removed, and the nanostructures are uniformly aligned.

### RELATED APPLICATIONS

This application claims the benefit of U.S. Provisional Application Ser. No. 60/563,652 filed Apr. 20, 2004, the entire disclosure of which is expressly incorporated herein by reference.

### STATEMENT OF GOVERNMENT INTERESTS

The present invention was made under a grant of the National Science Foundation, Grant No. DMR-0213706. Accordingly, the Government may have certain interests in the present invention.

### BACKGROUND OF THE INVENTION

1. Field of the Invention

The present invention relates to the alignment of nanostructures in thin films. More specifically, the present invention relates to shear-induced alignment of spherical nanodomains in block copolymer films.

2. Related Art

Nanofabrication is witnessing a rapid trend towards self-assembled templates as a cost-effective method of generating densely-patterned surfaces. Such surfaces are particularly desirable in forming high-density memory arrays and devices. Templating with block copolymer (BCP) thin films, until recently an area of essentially academic interest, has become increasingly popular in the semiconductor industry to form such densely-patterned surfaces. BCPs are macromolecules composed of two or more (“diblock copolymer” or “diBCP”) chemically distinct, covalently connected, polymer chains which are typically immiscible in bulk. In these polymers, molecular connectivity prohibits macroscopic phase separation. Instead, BCPs “microphase separate” to form nanoscale domains.

In diBCPs where one block is much shorter than the other, the minority blocks self-assemble into spherical nanodomains within a matrix of the majority block. If the length disparity is less pronounced, the nanodomains are cylindrical or lamellar. The self-assembled polymeric patterns obtained in this fashion can be used as templates for lithography, enabling economical and versatile patterning techniques that are capable of creating arrays of dielectric, metallic, quantum, or magnetic dots spaced tens of nanometers apart. Such techniques are fully compatible with silicon semiconductor processing and are presently being investigated for fabrication of memory devices, including magnetic hard disks and nanocrystal flash memories.

A significant shortcoming with existing template fabrication techniques is an inability to accurately and consistently align nanostructures in thin films. This results in a lack of order, and thus addressability, of nanodomains in the film, which limits data storage density to well below the theoretical maximum of one bit per nanodomain. While the resulting arrays typically display excellent short-range order, due to the existence of topological defects, only limited-range order can be achieved by traditional self-assembly, even when coupled with annealing. Recent research efforts have been directed at guiding the self-assembly process in order to induce long-range, in-plane order in the array of BCP nanodomains which define the template structures. However, the high degree of isotropy imposed by the hexagonal packing of the spherical nanodomains complicates the alignment problem. For example, electric fields, which are highly successful for in-plane alignment of cylinder-forming BCPs for defining templates of stripe arrays, have not been profitably applied to arrays of BCP spheres.

Accordingly, what would be desirable, but has not yet been provided, is a method and apparatus for providing shear-induced alignment of nanostructures in thin films, wherein uniform alignment of nanostructures is achieved with long-range order.

### SUMMARY OF THE INVENTION

The present invention provides a method and apparatus for aligning nanostructures in thin films. The method comprises the steps of forming, on a substrate, a thin film having nanostructures; annealing the thin film; applying a shear stress to the thin film during annealing; and allowing the nanostructures to align. The thin film could comprise a block copolymer (BCP) with spherical nanodomains formed therein, such as a poly(ethylene-alt-propylene) (PEP) matrix with polystyrene (PS) nanodomains formed therein, or a PS matrix with polyisoprene (PI) particles formed therein, or any other type of sphere-forming copolymer.

The present invention also provides an apparatus for aligning nanostructures in thin films. The apparatus comprises a substrate for receiving a thin film containing nanostructures to be aligned; means for annealing the thin film; and means for imparting a shear stress on the thin film. The means for imparting a shear stress comprises, in one embodiment of the present invention, a flexible or rigid pad positioned on the thin film and means for moving the pad with respect to the substrate. A weight could be placed on the pad to ensure uniform contact between the pad and the thin film. In another embodiment of the present invention, a thin fluid layer is provided between the pad and the thin film, wherein shear stress is transmitted through the thin fluid layer to the thin film. The fluid layer could comprise a viscous silicone, hydrocarbon oil, or other suitable fluid. Optionally, the pad and weight could be replaced with a rolling apparatus, and shear applied to the thin film using a rolling process to align nanostructures in the film. Further, shear could be applied to the thin film using a confined channel and a fluid flowing through the channel.

### BRIEF DESCRIPTION OF THE DRAWINGS

Other important objects and features of the invention will be apparent from the following Detailed Description of the Invention taken in connection with the accompanying drawings in which:

FIG. 1 is a cross-sectional view showing a thin film having nanostructures to be aligned, wherein the thin film is positioned in the apparatus of the present invention and a shear stress is applied to the film.

FIG. 2 is a cross-sectional view of another embodiment of the present invention, wherein a thin fluid layer is positioned between the pad and the thin film.

FIG. 3 is a top view showing alignment of two layers of spherical nanodomains in a BCP thin film achieved by the present invention.

FIGS. 4a-4b are tapping-mode atomic force microscopy (TM-AFM) images of sheared bilayer films of a polystyrene-poly(ethylene-alt-propylene) diblock copolymer (PS-PEP) produced by the present invention, taken at two separate locations on a single cm² sample.

FIG. 5 is a TM-AFM image showing a disordered PS-PEP film resulting from shearing films that are slightly thicker or thinner than a bilayer.

FIG. 6 is a scanning electron microscopy (SEM) image of a sheared thin film bilayer of polystyrene (PS)/polyisoprene (PI) produced by the present invention.

FIG. 7 is a diagram showing an alternate embodiment of the present invention, wherein shear stress is applied to a thin film using a rolling apparatus.

FIG. 8 is a diagram showing an alternate embodiment of the present invention, wherein shear stress is applied using a confining channel and a fluid flowing therethrough.

### DETAILED DESCRIPTION

The present invention relates to a method and apparatus for providing shear-induced alignment of nanostructures in thin films, such as block co-polymer (BCP) thin films. The term “nanostructure,” as used herein, includes but is not limited to, spherical nanodomains, self-assembled nanodomains, and particles. A substrate is provided, and a thin film layer having nanostructures therein is formed on the substrate. The thin film could be formed by spin coating, flow coating, or other suitable technique. A flexible or rigid pad, such as an elastomer pad, polished metal plate, or silicon wafer, is positioned on the thin film layer. A weight could be positioned on the pad to ensure uniform contact between the pad and the film. The film is annealed and the pad moved with respect to the substrate to impart a shear stress to the film during annealing. The shear stress aligns the nanostructures in the film. After annealing and application of the shear stress, the pad is removed, and the nanostructures remain uniformly aligned. Optionally, a thin fluid layer could be provided between the pad and the thin film to transmit shear stress from the pad to the film. Further, the pad and the weight could be replaced with a rolling apparatus, and shear stress applied to the thin film using a rolling process. Additionally, the shear stress could be applied using a confining channel with a fluid flowing therethrough.

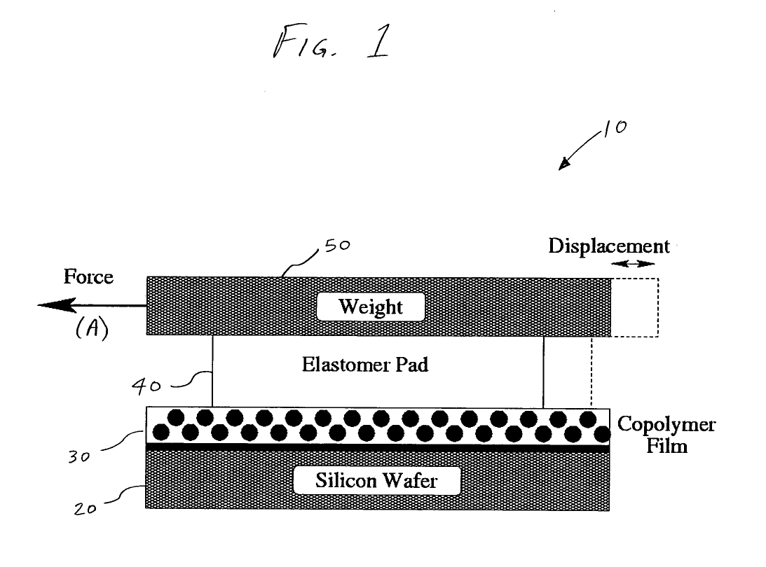

FIG. 1 is a cross-sectional view showing a thin film 30 having nanostructures to be aligned and positioned in the apparatus 10 of the present invention. The apparatus 10 comprises a substrate 20 with a uniformly flat surface and a pad 40 applied to the thin film 30. The substrate 20 could comprise a silicon wafer, or any other suitable material. The pad 40 could comprise a pad made of an elastomer, a rigid solid, or other suitable material. A weight 50 could be positioned on the pad 40 to ensure uniform contact between the pad 40 and the film 30. To align nanostructures in the film 30, the silicon substrate 20 is first polished to form a clean and uniform surface. The substrate 20 is approximately 400 microns in thickness, but any suitable thickness could be used. Then, the film 30 is formed on the substrate 20. The film 30 could comprise a block copolymer (BCP), which could be produced by living anionic polymerization, and optionally, with subsequent chemical modification such as hydrogenation. Examples of suitable BCP materials include, but are not limited to, a polystyrene-b-poly(ethylene-alt-propylene) (PS-PEP 3-23) layer with block molecular weights of 3 kg/mol (PS) and 23 kg/mol (PEP), and a polystyrene-b-polyisoprene (PS-PI 68-12) layer with block molecular weights of 68 kg/mol (PS) and 12 kg/mol (PI). The bulk morphology of the film 30 comprises spherical nanodomains wherein the minority copolymer block is embedded in a matrix comprising the majority copolymer block in a body-centered cubic (bcc) structure. For thin films, the spherical nanodomains assemble into hexagonally-packed arrays.

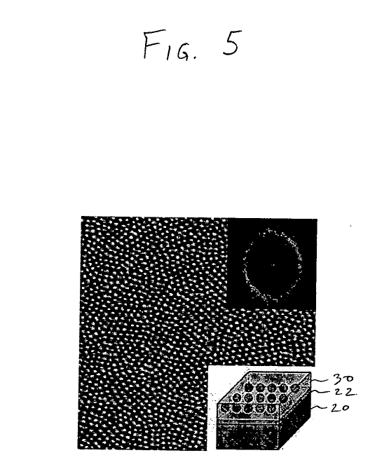

Thin films of the BCP could be cast from a dilute (1-2%) solution using spin coating, flow coating, or any other suitable technique known in the art. Suitable thicknesses of the film 30 can range from a few nanometers to several hundred nanometers. However, as will be discussed later with reference to FIG. 5, the thickness of the film 30 must be carefully controlled in order to ensure uniform alignment of nanostructures in the film 30.

After formation of the film 30, the pad 40 is positioned on the film 30. The film 30 is then annealed by heating to a temperature between the glass transition temperature and the order-disorder transition temperature (T_{g}<T<T_{ODT}) of the polymer forming the layer 30. Optionally, a weight 50 could be positioned on the pad 40. The pad 40 could be formed of a polydimethylsiloxane (PDMS) elastomer or other suitable material. In the examples disclosed herein, the pad 40 has an area of approximately 1 cm², but of course, other dimensions could be provided without departing from the spirit or scope of the present invention. Further, the pad 40 has a thickness of approximately 0.5 to 4 millimeters, but other thicknesses could be used. Weight 50, if utilized, has a mass of approximately 2 kilograms, but other masses could be provided. It should be noted that the present invention can be practiced without the pad 40 and weight 50, wherein the pad 40 and weight 50 are replaced with a rolling apparatus and shear is imparted to the film using a rolling process. Additionally, the stress could be imparted using a confining channel with a fluid flowing therethrough. Any suitable means for imparting shear to the film can be used without departing from the spirit and scope of the present invention.

As shown in FIG. 1, a shear stress is applied to the film while the film 30 is annealed. The shear stress is applied to the film 30 by slowly moving the pad 40 and weight 50 (if utilized) in a lateral direction (e.g., a direction parallel to the substrate 10), indicated generally by the arrow A. The stress is applied for the duration of the annealing process, which typically lasts between a few minutes to a few hours, but could vary. The magnitude of the stress applied to the film 30 depends on the lateral pulling force applied to the pad 40 and the area of contact between the pad 40 and the film 30. The pad 40 moves at a rate of approximately 40 nm/sec with respect to the substrate 20, but this velocity can vary according to the shear stress applied, temperature, composition of the film 30, and the mass of weight 50 (if utilized). The shearing process creates alignment of nanostructures in thin films. After annealing and movement of the pad, the pad 40 is removed from the film 30 and temperature is reduced to ambient temperature. During cooling, the nanostructures remain aligned.

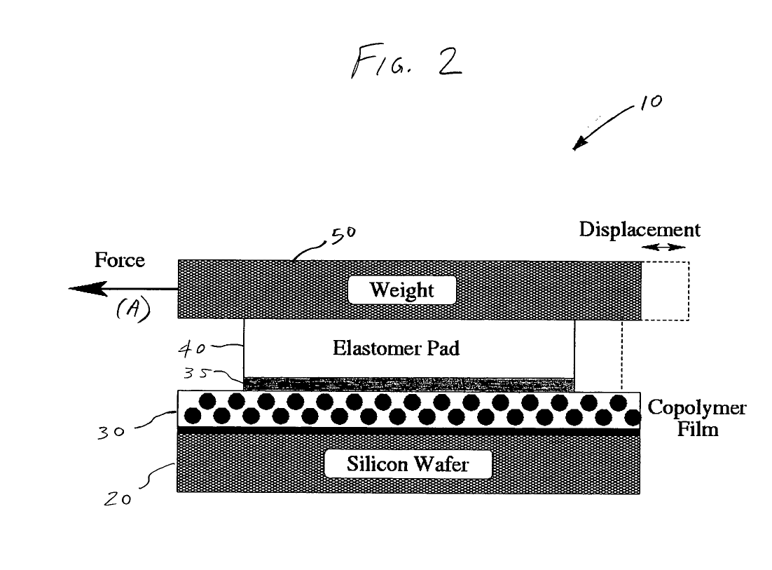

FIG. 2 is a cross-sectional view of another embodiment of the present invention, wherein a thin fluid layer 35 is positioned between the pad 40 and the thin film 30. The fluid layer 35 could comprise a viscous silicone or hydrocarbon oil, or other suitable material. Similar to the embodiment discussed earlier with respect to FIG. 1, the weight 50 (if utilized) and the pad 40 are moved in the lateral direction A. Shear stress is transmitted through the fluid layer 35 and to the thin film 30, to align nanostructures in the film 30. Importantly, the fluid layer 35 allows the pad 40 to be easily removed from the film 30 after alignment has been achieved. If the fluid layer 35 is utilized, the pad 40 need not be manufactured from an elastomer and could comprise a hard, solid surface such as a metal sheet or a silicon wafer.

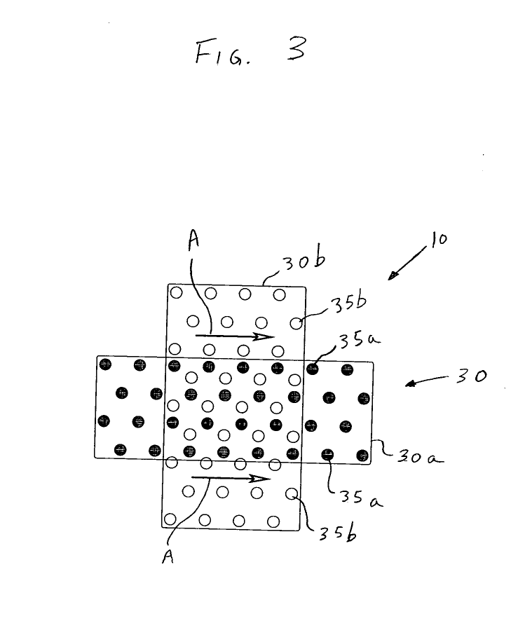

An explanation of the alignment achieved by the present invention can be appreciated with reference to FIG. 3. The film 30 includes a number of spherical nanodomains which are intrinsic to the BCP material and which are stacked in different layers. For purposes of illustration, the film 30 comprises a first layer 30a having a plurality of spherical nanodomains 35a, and a second layer 30b having a plurality of spherical nanodomains 35b. When the stress A is applied to the pad 40, the layer 30a moves with respect to the layer 30b, and consequently, the nanodomains 35a move with respect to the nanodomains 35b. The shear stress A must be sufficiently strong to break the lattice formed by the nanodomains in the film 30. The critical shear stress depends upon the chemical composition and thickness of the film 30. For PS-PEP 3-23, the critical stress required to break the lattice is approximately 400 Pascals.

The spherical nanodomains 35a, 35b are dynamic in that they can be broken and re-assembled. The nanodomains 35a of the top layer 30a can easily slide in the spaces between the nanodomains 35b of the bottom layer 30b when the shear stress A is applied. When the shear stress A is applied, nanodomains having lattice axes normal to the direction of shear (“perpendicular” configuration) break under the shear stress, and re-assemble into nanodomains having lattice axes parallel to the direction of shear (“parallel” configuration, as shown in FIG. 3). Fluctuations in orientations of the nanodomains are thereby reduced, resulting in a highly-ordered (aligned) arrangement of nanodomains. Further, the sheared film 30 strongly inhibits the formation of dislocations in the layer. This is advantageous in that a single, isolated dislocation would result in several nanodomains assembled in the perpendicular configuration, which would cause spheres to jam into each other rather than sliding through the troughs of nanodomains in the adjacent layer.

The alignment of nanostructures achieved by the present invention can be appreciated with reference to the following Examples, which are supplied for purposes of illustration only and are not intended to limit the spirit or scope of the present invention:

### EXAMPLE 1

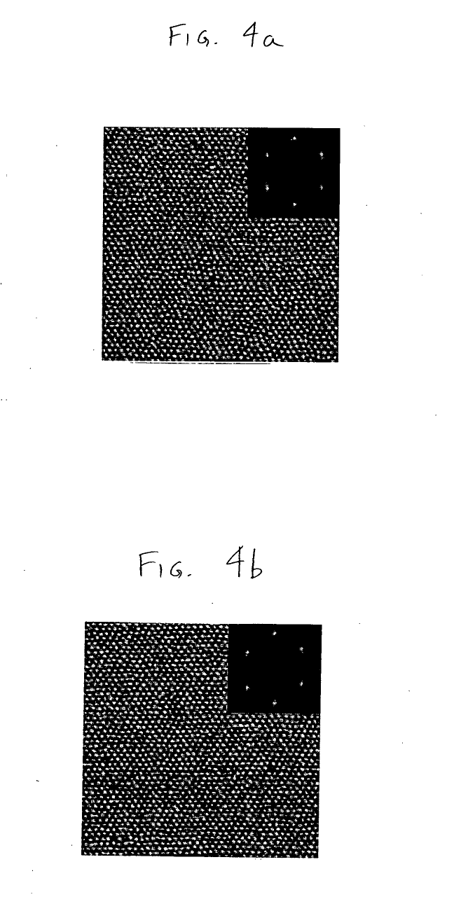

FIGS. 4a-4b are tapping-mode atomic force microscopy (TM-AFM) images of a sheared PS-PEP 3-23 BCP bilayer film produced by the present invention, taken at two separate locations on a single cm² sample. The BCP film was approximately 50 nm in thickness, which corresponds to the thickness of two layers of nanodomains. The substrate thickness was approximately 500 microns, and a PDMS pad having a thickness of approximately 1 mm and an area of approximately 1 cm² was utilized. A shearing force of approximately 0.8 N was applied to the pad, and a weight of approximately 9.8 N was provided on the pad. The sample was heated to a temperature of approximately 100 degrees C., and the BCP layer was sheared for approximately 20 minutes. As can be seen in both images, TM-AFM imaging revealed an aligned hexagonal lattice over the full extent of the sheared region of the BCP layer, with one of the lattice directions coinciding with the shear direction. The inserts in FIGS. 4a-4b show Fourier transforms, wherein the six dots indicate the uniform orientation of the samples in the direction of shear.

To investigate the quality of the alignment, the distribution of topological defects (disclinations and dislocations) were determined using computerized image analysis tools. The orientational order of the lattice was perfect over the entire sheared region, and no disclinations were identified anywhere in the sample (which consisted of a single grain). Translational order was good, but was limited by the presence of occasional isolated dislocations, which appeared, on average, 6 times per square micrometer. For purposes of comparison, samples annealed at similar temperatures for much longer time (e.g., 4 hours), but without shear, developed a multigrain structure with high topological defect densities (an average of 18 disclinations and 150 dislocations per square micron). Thus, the present invention achieves significant alignment of nanostructures, with high order.

### EXAMPLE 2

As mentioned earlier, the thickness of the BCP layer significantly affects the quality of alignment produced by the present invention. This can be appreciated with reference to FIG. 5, which is a TM-AFM image showing a disordered BCP bilayer film resulting from shear stress applied to slightly thicker and thinner films, as well as monolayer films. The BCP film was approximately 49 nm in thickness. The substrate thickness was approximately 500 microns, and a PDMS pad having a thickness of approximately 1 mm and an area of approximately 1 cm² was utilized. A shearing force of approximately 0.8 N was applied to the pad, and a weight of approximately 9.8 N was provided on the pad. The sample was heated to a temperature of approximately 100 degrees C., and the BCP layer was sheared for approximately 20 minutes.

The image of FIG. 5 shows a completely disordered lattice, with no translational or orientational order. The density of topological defects is also very high, with approximately 40 disclinations and 300 dislocations occurring per square micron. To study the dependence of alignment quality on film thickness, a flow-coating technique was used to create films with a thickness gradient along one direction, which were then sheared in a direction normal to the thickness gradient using an elastomer pad in direct contact with the film. The resulting samples showed alignment within a band corresponding to approximately 1 nm thickness variation, or 2% of the bilayer thickness. Consistently, for films created by spin-coating, a change of +/−3% in spin speed resulted in disordered samples. Thus, shear-alignment in bilayer BCP films is dependent upon film thickness. The insert in the top-right corner of FIG. 5 shows a Fourier transform in the form of a circle, indicating random orientation of the nanodomain lattice.

Secondary ion mass spectrometry studies of a similar PS-PEP BCP thin film that forms PS cylinders revealed the existence of a PS wetting layer between the silicon substrate and the BCP thin film, which can facilitate rearrangement of the nanostructures. As such, a wetting layer can optionally be present between the substrate 20 and the film 30 to facilitate the rearrangement of nanostructures. Such a wetting layer is shown in the insert in FIG. 5, and is indicated generally as 22.

### EXAMPLE 3

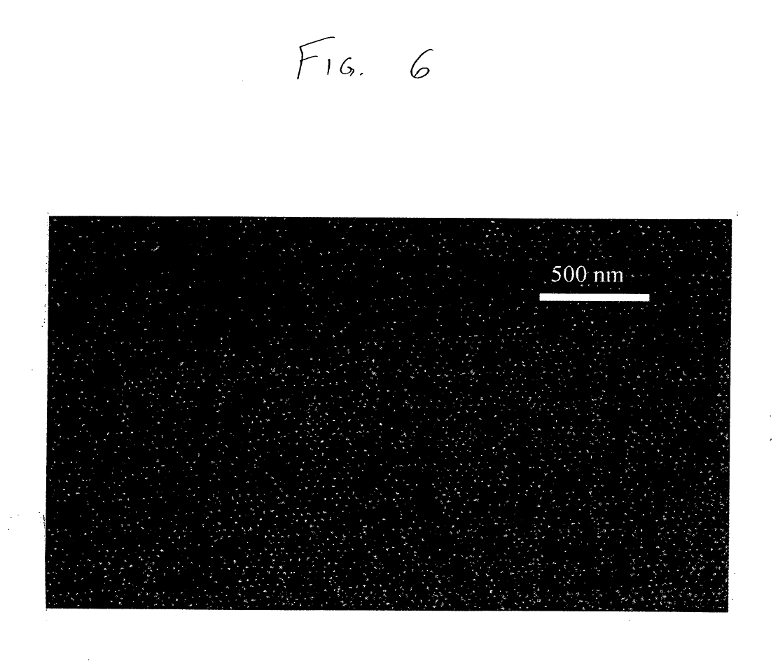

FIG. 6 is a scanning electron microscope (SEM) image of an aligned BCP thin film of polyisoprene (PI) spheres in a polystyrene (PS) matrix taken with staining of the film using osmium tetroxide. It has been found that good alignment can be achieved with a PS-PI 68-12 BCP layer having a thickness of 110 nm. At room temperature, PI is a rubber and PS is a glass. The PS-PI 68-12 layer is heated to 180° C., wherein the PI and PS materials are fluids. The PS-PI 68-12 BCP layer is formed on the substrate in similar fashion as the PS-PEP 3-23 BCP layer discussed earlier, and an elastomer pad applied to the PS-PI 68-12 BCP layer. The substrate thickness was approximately 400 microns, and a PDMS pad having a thickness of approximately 1 mm and an area of approximately 1 cm² was utilized. A shearing force of approximately 0.07 N was applied to the pad, and a weight of approximately 9.8 N was provided on the pad. The sample was heated to a temperature of approximately 180 degrees C., and the BCP layer was sheared for approximately 9 hours.

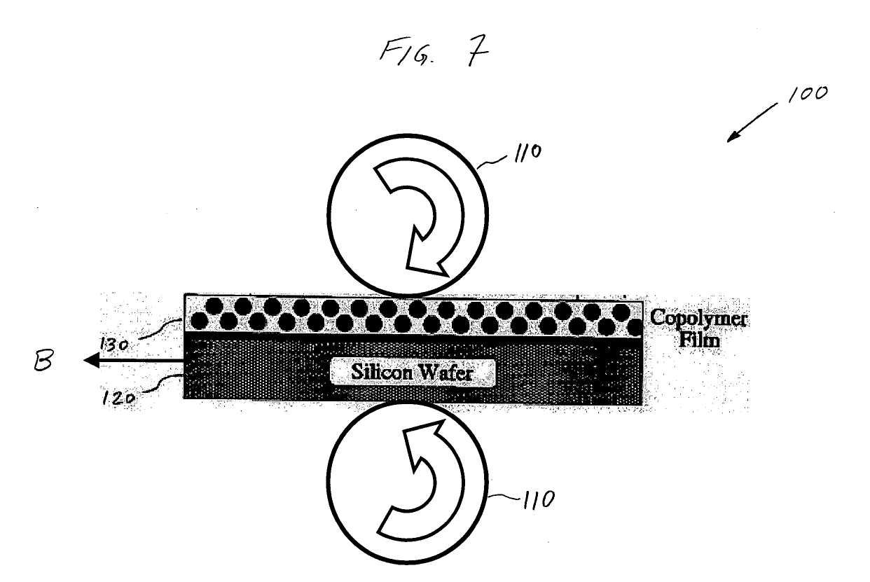

FIG. 7 is a diagram showing an alternate embodiment of the present invention, indicated generally at 100, wherein shear stress is applied to a thin film using a rolling apparatus 110. The rolling apparatus could comprise a pair of cylindrical rollers 110 having an adjustable gap therebetween. The substrate 120 and the BCP film 130 are fed through the rollers 110 in the general direction indicated by arrow B. Optionally, a fluid layer could be used between the rollers 110 and the BCP film 130. The rolling action of the rollers 110 imparts a shear force on the film 130 sufficient to align nanostructures in the film.

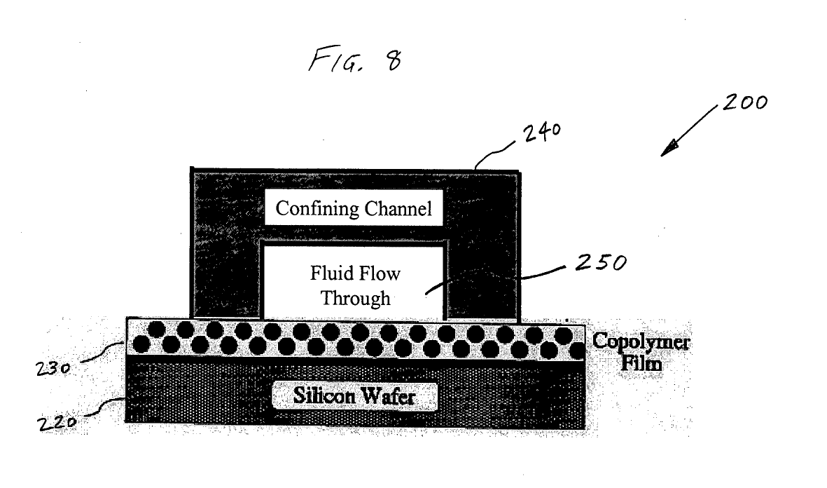

FIG. 8 is a diagram showing an alternate embodiment of the present invention, indicated generally at 200, wherein shear stress is applied using a confining channel 240 and a fluid 250 flowing therethrough. The fluid 250 generates a shear force sufficient to align nanostructures in the film 230.

In conclusion, the present invention provides a method and apparatus capable of creating BCP templates for arrays of spherical nanodomains (dots) that are well-aligned over cm² regions. It should be noted that the invention could be expanded to provide arrays of well-aligned regions of any desired size by increasing the area of the thin film to which the shear stress is applied (e.g., by increasing the area of the pad). In this manner, mass-fabrication of ultradense memory devices can be achieved.

Having thus described the invention in detail, it is to be understood that the foregoing description is not intended to limit the spirit and scope thereof. What is desired to be protected by letters patent is set forth in the appended claims.

What is claimed is:

1. A method for aligning nanostructures in a thin film comprising:
forming on a substrate a thin film having nanostructures;
annealing the thin film;
applying a shear stress to the film during annealing; and
allowing the nanostructures to align.

2. The method of claim 1, wherein the step of forming the thin film comprises forming a block copolymer having spherical nanodomains on a silicon substrate.

3. The method of claim 2, wherein the step of forming the block copolymer comprises forming poly(ethylene-alt-propylene) having polystyrene spherical nanodomains on the silicon substrate.

4. The method of claim 2, wherein the step of forming the block copolymer comprises forming polystyrene having polyisoprene spherical nanodomains on the silicon substrate.

5. The method of claim 1, further comprising placing a pad on the thin film.

6. The method of claim 5, wherein the step of placing the pad on the thin film comprises placing an elastomer pad on the thin film.

7. The method of claim 5, wherein the step of placing a pad on the thin film comprises placing a silicon wafer on the thin film.

8. The method of claim 5, wherein the step of placing a pad on the thin film comprise placing a metal sheet on the thin film.

9. The method of claim 5, further comprising imparting a force on the pad to apply the shear stress to the thin film.

10. The method of claim 5, further comprising positioning a weight on the pad.

11. The method of claim 5, further comprising removing the pad from the thin film without damaging the thin film.

12. The method of claim 1, further comprising forming a fluid layer on the thin film.

13. The method of claim 12, further comprising placing a pad on the fluid layer.

15. The method of claim 13, wherein the step of placing the pad on the fluid layer comprises placing an elastomer pad on the fluid layer.

16. The method of claim 13, wherein the step of placing the pad on the fluid layer comprises placing a silicon wafer on the fluid layer.

17. The method of claim 13, wherein the step of placing the pad on the fluid layer comprises placing a metal sheet on the fluid layer.

18. The method of claim 1, wherein the step of applying the shear stress comprises applying the shear stress to the thin film along the plane of the film.

19. The method of claim 1, wherein the step of applying the shear stress comprises applying a rolling process to the thin film to apply shear stress to the film.

20. The method of claim 1, wherein the step of applying the shear stress comprises flowing a fluid across the thin film to apply shear stress to the film.

21. An apparatus for aligning nanostructures in thin films comprising:
a substrate for receiving a thin film containing nanostructures to be aligned;
means for annealing the thin film; and
means for imparting a shear stress on the thin film.

22. The apparatus of claim 21, wherein the substrate comprises a silicon substrate.

23. The apparatus of claim 21, wherein the thin film comprises a block copolymer having spherical nanodomains formed therein.

24. The apparatus of claim 21, wherein the block copolymer comprises poly(ethylene-alt-propylene) having polystyrene spherical nanodomains formed therein.

25. The apparatus of claim 21, wherein the block copolymer comprises polystyrene having polyisoprene spherical nanodomains formed therein.

26. The apparatus of claim 21, wherein the means for imparting a shear stress comprises a pad positioned on the thin film and means for moving the pad with respect to the substrate.

27. The apparatus of claim 26, wherein the pad comprises an elastomer pad.

28. The apparatus of claim 21, further comprising a fluid layer positioned between the pad and the thin film.

29. The apparatus of claim 28, wherein the fluid layer comprises a viscous silicone oil.

30. The apparatus of claim 28, wherein the fluid layer comprises a hydrocarbon oil.

31. The apparatus of claim 27, wherein the pad comprises a silicon wafer.

32. The apparatus of claim 27, wherein the pad comprises a metal sheet.

33. The apparatus of claim 26, further comprising a weight positioned on the pad.

34. The apparatus of claim 21, wherein the means for imparting a shear stress comprises a rolling apparatus for rolling the thin film to impart shear stress to the film.

35. The apparatus of claim 21, wherein the means for imparting a shear stress comprises a fluid flowing across the thin film to impart shear stress to the film.

36. The apparatus of claim 35, further comprising a confining channel for confining fluid flow across the thin film.
